(19) United States
(12) Patent Application Publication
(10) Pub. No.: US 2022/0203504 A1
(43) Pub. Date: Jun. 30, 2022

(54) TOOL WITH TWO HANDLES

(71) Applicant: Hong Ann Tool Industries Co., Ltd., Taichung City (TW)

(72) Inventor: Cheng-Wei SU, Taichung City (TW)

(21) Appl. No.: 17/698,298

(22) Filed: Mar. 18, 2022

Related U.S. Application Data
(63) Continuation-in-part of application No. 17/082,277, filed on Oct. 28, 2020.

(30) Foreign Application Priority Data
Dec. 4, 2019 (TW) 108144320
Sep. 7, 2021 (TW) 110133262

(51) Int. Cl. B25B 7/02; B25B 7/18; B25B 7/12

(52) U.S. Cl. CPC B25B 7/02; B25B 7/12; B25B 7/18

(57) ABSTRACT

A tool includes a first member, a second member, a reinforcing device and a fastening assembly. The first member has at least one first working portion and a first pivoting portion. The second member has at least one second working portion and a second pivoting portion. The reinforcing device is arranged between the first member and the second member and configured to abut in surface contact against the first pivoting portion and the second pivoting portion. The fastening assembly inserts through the first pivoting portion, the second pivoting portion and the reinforcing device so that the first pivoting portion and the second pivoting portion are pivotally connected to each other.

### CROSS-REFERENCE

The present application is a continuation-in-part application of U.S. patent application Ser. No. 17/082,277, filed on Oct. 28, 2020, now pending, which claims priority of Taiwan patent application Ser. No. 108144320, filed on Dec. 4, 2019, of which the entire disclosure is incorporated herein by reference for all purposes.

### BACKGROUND OF THE INVENTION

The present invention relates to a hand-operated tool with two handles and, more particularly, to a hand-operated tool with two handles utilizing the principle of leverage.

Generally, a double-handled hand tool utilizing the principle of leverage is composed of two working arms pivoted to each other. The two working arms are pivotally connected through a pivot acting as a fulcrum, and each working arm has a handle and a working head opposite to the handle, so as the mechanical advantage of a lever can be exploited by placing an object to be worked as close to the fulcrum as possible.

However, the two working arms can be pivoted to each other by only connecting a pivot pin to the two working arms, but when the external force applied to the handle is too large, the two working arms will inevitably sway, resulting in the working head unable to work properly.

Thus, a need exists for a novel tool that mitigates and/or obviates the above drawbacks.

### BRIEF SUMMARY OF THE INVENTION

An objective of the present invention is to provide a tool with two handles, which includes a first member, a second member, a reinforcing device, and a fastening assembly. The first member has at least one first working portion and a first pivoting portion. The second member has at least one second working portion and a second pivoting portion. The reinforcing device is arranged between the first member and the second member and is configured to abut in surface contact against the first pivoting portion and the second pivoting portion. The fastening assembly inserts through the first pivoting portion, the second pivoting portion, and the reinforcing device so that the first pivoting portion and the second pivoting portion are pivotally connected to each other.

In an example, the reinforcing device includes a first gasket, a second gasket, and a spacer arranged between the first gasket and the second gasket. The first gasket abuts in surface contact against the first pivoting portion. The second gasket abuts in surface contact against the second pivoting portion. The spacer abuts against the first gasket and the second gasket.

In an example, the first pivoting portion has a first abutting face. The first member further has a first abutting recess adjacent to the first abutting face, and a first containing recess spaced from the first abutting recess. The second pivoting portion has a second abutting face. The second member further has a second abutting recess adjacent to the second abutting face, and a second containing recess spaced from the second abutting recess. The first gasket is arranged in the first abutting recess and the second containing recess and has a first external side face abutting against the first abutting face, a first internal side face opposite to the first external side face, and a first through hole penetrating through the first external side face and the first internal side face. The second gasket is arranged in the second abutting recess and the first containing recess and has a second external side face abutting against the second abutting face, a second internal side face opposite to the second external side face, and a second through hole penetrating through the second external side face and the second internal side face. The spacer has a first end face, a second end face opposite to the first end face, and a third through hole penetrating through the first end face and the second end face. The fastening assembly includes a bolt and a nut threaded connected with the bolt. The bolt inserts through the first pivoting portion, the second pivoting portion, the first through hole, the second through hole, and the third through hole.

In an example, each of the first gasket and the second gasket is formed in a disc shape and has a circular cross sectional shape. The spacer is cylindrical and has a circular cross sectional shape.

In an example, the first gasket, the second gasket and the spacer are made of metal.

In an example, the number of the at least one first working portion of the first member is two. The two first working portions are respectively disposed at two ends of the first member, and the first pivoting portion is disposed between the two first working portions. The first member further has a first gripping portion arranged at an outer side thereof and disposed between one of the two first working portions and the first pivoting portion. The number of the at least one second working portion of the second member is two. The two second working portions are respectively disposed at two ends of the second member, and the second pivoting portion is disposed between the two second working portions. The second member further has a second gripping portion arranged at an outer side thereof and disposed between one of the two second working portions and the second pivoting portion.

In an example, the first member further has at least one first limiting rib disposed at an inner side thereof. The second member further has at least one second limiting rib disposed at an inner side thereof. The at least one first limiting rib and the at least one second limiting rib abut against each other.

In an example, the number of the at least one first limiting rib of the first member is two. The two first limiting ribs are spaced from each other.

The number of the at least one second limiting rib of the second member is two. The two second limiting ribs are spaced from each other. One of the two first limiting ribs is configured to be located between the two second limiting ribs when the first member and the second member pivot to each other.

In another example, the number of the at least one first limiting rib of the first member is two. The two first limiting ribs are staggered with each other along a width direction of the first member. The number of the at least one second limiting rib of the second member is two. The two second limiting ribs are staggered with each other along a width direction of the second member. The two first limiting ribs is configured to abut against the two second limiting ribs when the first member and the second member pivot to each other.

In an example, the first member is embedded with a first metal reinforcing member. The second member is embedded with a second metal reinforcing member.

In an example, the first member and the second member are made of metal.

In another example, the tool further includes a elastic member arranged between the first member and the second member and configured to elastically bias the first member and the second member outward respectively. The elastic member is a torsion spring.

Another objective of the present invention is to provide a tool with two handles, which includes a first member, a second member, and a fastening assembly. The first member has at least one first working portion and a first pivoting portion. The first member further has at least one first limiting rib disposed at an inner side thereof. The second member has at least one second working portion and a second pivoting portion. The second member further has at least one second limiting rib disposed at an inner side thereof. The at least one first limiting rib and the at least one second limiting rib abut against each other. The fastening assembly inserts through the first pivoting portion and the second pivoting portion so that the first pivoting portion and the second pivoting portion are pivotally connected to each other.

In an example, the number of the at least one first limiting rib of the first member is two. The two first limiting ribs are spaced from each other.

The number of the at least one second limiting rib of the second member is two. The two second limiting ribs are spaced from each other. One of the two first limiting ribs is configured to be located between the two second limiting ribs when the first member and the second member pivot to each other.

In another example, the number of the at least one first limiting rib of the first member is two. The two first limiting ribs are staggered with each other along a width direction of the first member. The number of the at least one second limiting rib of the second member is two. The two second limiting ribs are staggered with each other along a width direction of the second member. The two first limiting ribs is configured to abut against the two second limiting ribs when the first member and the second member pivot to each other.

The present invention will become clearer in light of the following detailed description of illustrative embodiments of this invention described in connection with the drawings.

### DESCRIPTION OF THE DRAWINGS

FIG. 1 is a perspective view of a tool with two handles of a first embodiment according to the present invention.

FIG. 2 is an exploded, perspective view of the tool of FIG. 1.

FIG. 3 is a cross sectional view of the tool of FIG. 1.

FIG. 4 is a perspective view of a tool with two handles of a second embodiment according to the present invention.

FIG. 5 is an exploded, perspective view of a tool with two handles of a third embodiment according to the present invention.

FIGS. 6 and 7 are cross sectional views of the tool of FIG. 5.

### DETAILED DESCRIPTION OF THE INVENTION

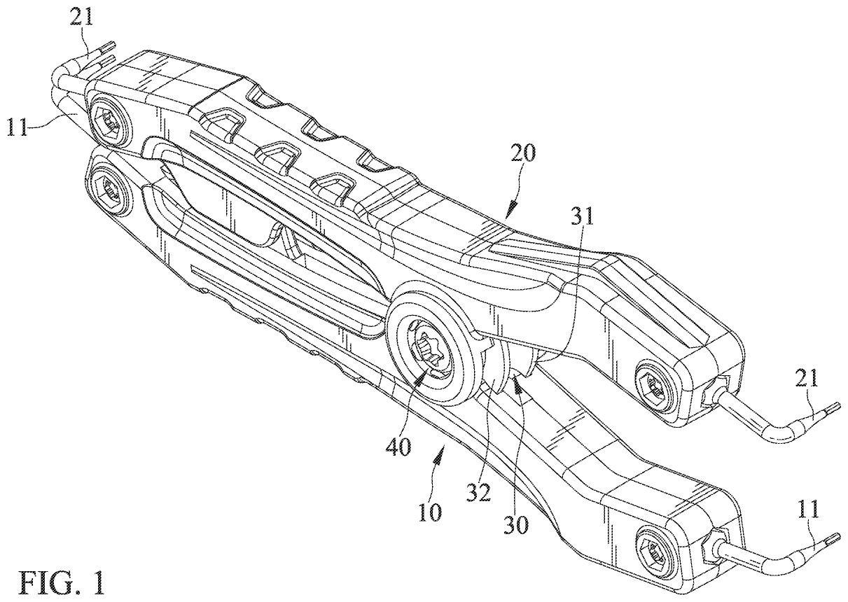

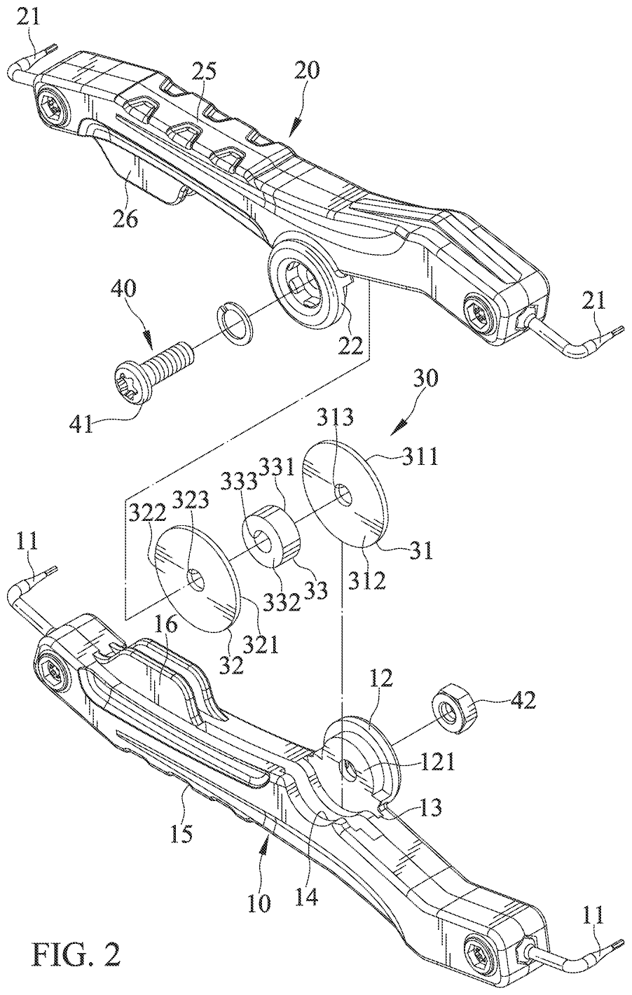

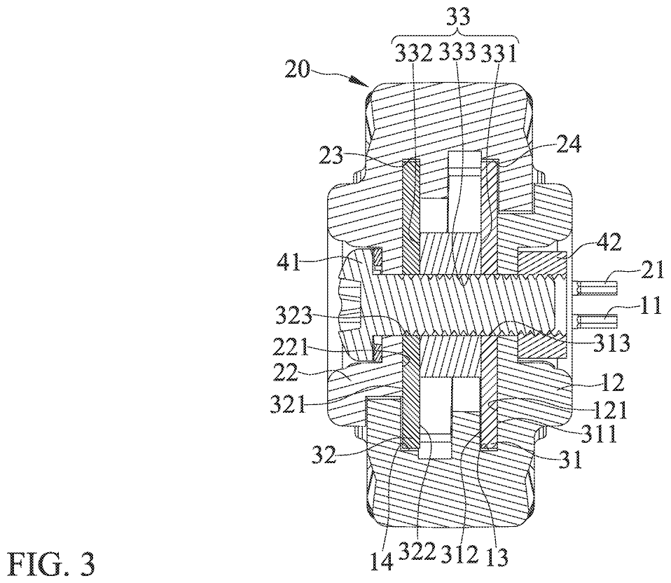

FIGS. 1-3 show a tool with two handles of a first embodiment according to the present invention. The tool includes a first member 10, a second member 20, a reinforcing device 30, and a fastening assembly 40.

The first and second members 10 and 20 of the embodiment may be used as handles. The first member 10 has at least one first working portion 11 and a first pivoting portion 12. The second member 20 has at least one second working portion 21 and a second pivoting portion 22. The reinforcing device 30 is arranged between the first member 10 and the second member 20 and is configured to abut in surface contact against the first pivoting portion 12 and the second pivoting portion 22. The fastening assembly 40 inserts through the first pivoting portion 12, the second pivoting portion 22, and the reinforcing device 30 so that the first pivoting portion 12 and the second pivoting portion 22 are pivotally connected to each other. Further, the reinforcing device 30 includes a first gasket 31, a second gasket 32 and a spacer 33 arranged between the first gasket 31 and the second gasket 32. The first gasket 31 abuts in surface contact against the first pivoting portion 12. The second gasket 32 abuts in surface contact against the second pivoting portion 22, and the spacer 33 abuts against the first gasket 31 and the second gasket 32. Therefore, by the first gasket 31 and the second gasket 32 respectively abutting in surface contact against the first pivoting portion 12 and the second pivoting portion 22, the contact areas between the reinforcing device 30 and the first and second pivoting portions 12 and 22 are added, thereby preventing the first member 10 and the second member 20 from swaying relative to the fastening assembly 40 when an external force is applied.

In order to stably dispose the first gasket 31 and the second gasket 32 in the first member 10 and the second member 20, the first pivoting portion 12 has a first abutting face 121. The first member 10 further has a first abutting recess 13 adjacent to the first abutting face 121, and a first containing recess 14 spaced from the first abutting recess 13. The second pivoting portion 22 has a second abutting face 221. The second member 20 further has a second abutting recess 23 adjacent to the second abutting face 221, and a second containing recess 24 spaced from the second abutting recess 23. The first gasket 31 is arranged in the first abutting recess 13 and the second containing recess 24 and has a first external side face 311 abutting against the first abutting face 121, a first internal side face 312 opposite to the first external side face 311, and a first through hole 313 penetrating through the first external side face 311 and the first internal side face 312. The second gasket 32 is arranged in the second abutting recess 23 and the first containing recess 14 and has a second external side face 321 abutting against the second abutting face 221, a second internal side face 322 opposite to the second external side face 321, and a second through hole 323 penetrating through the second external side face 321 and the second internal side face 322. The spacer 33 has a first end face 331, a second end face 332 opposite to the first end face 331, and a third through hole 333 penetrating through the first end face 331 and the second end face 332. The fastening assembly 40 includes a bolt 41 and a nut 42 threaded connected with the bolt 41, and the bolt 41 inserts through the first pivoting portion 12, the second pivoting portion 22, the first through hole 313, the second through hole 323, and the third through hole 333.

In the embodiment, each of the first gasket 31 and the second gasket 32 may be formed in a disc shape and has a circular cross sectional shape, and the spacer 33 may be cylindrical and have a circular cross sectional shape. In addition, the first gasket 31, the second gasket 32, and the spacer 33 may be made of metal, and the first member 10 and the second member 20 may be made of plastic.

In the embodiment, the number of the at least one first working portion 11 of the first member 10 is two. The two first working portions 11 are respectively disposed at two ends of the first member 10, and the first pivoting portion 12 is disposed between the two first working portions 11. The first member 10 further has a first gripping portion 15 arranged at an outer side thereof and disposed between one of the two first working portions 11 and the first pivoting portion 12. The number of the at least one second working portion 21 of the second member 20 is two. The two second working portions 21 are respectively disposed at two ends of the second member 20, and the second pivoting portion 22 is disposed between the two second working portions 21, and the second member 20 further has a second gripping portion 25 arranged at an outer side thereof and disposed between one of the two second working portions 21 and the second pivoting portion 22.

Therefore, one set of the first working portion 11 and the second working portion 21 can connect to two holes of an external retaining ring, and another set the first working portion 11 and the second working portion 21 can connect to two holes of an internal retaining ring. Thus, the tool of the embodiment can be applied to the external or internal retaining ring at the same time. Further, the external or internal retaining ring can be attached or detached by simply pressing the first gripping portion 15 and the second gripping portion 25.

The first member 10 further has at least one first limiting rib 16 disposed at an inner side thereof. The second member 20 further has at least one second limiting rib 26 disposed at an inner side thereof, and the at least one first limiting rib 16 and the at least one second limiting rib 26 abut against each other. In the embodiment, the number of the at least one first limiting rib 16 of the first member 10 is two. The two first limiting ribs 16 are spaced from each other. The number of the at least one second limiting rib 26 of the second member 20 is two. The two second limiting ribs 26 are spaced from each other, and wherein one of the two first limiting ribs 16 is configured to be located between the two second limiting ribs 26 when the first member 10 and the second member 20 pivot to each other.

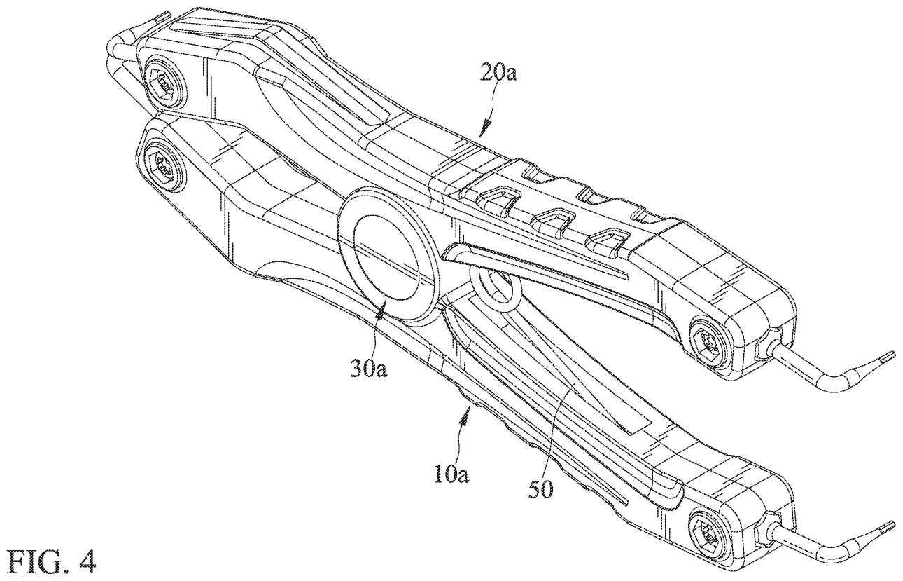

FIG. 4 shows a tool with two handles of a second embodiment according to the present invention. The second embodiment is substantially the same as the first embodiment but is mainly different from the first embodiment by that the first member 10a and the second member 20a are made of metal, and the tool further includes a elastic member 50 arranged between the first member 10a and the second member 20a and configured to elastically bias the first member 10a and the second member 20a outward respectively. Further, the elastic member 50 of the embodiment may be a torsion spring.

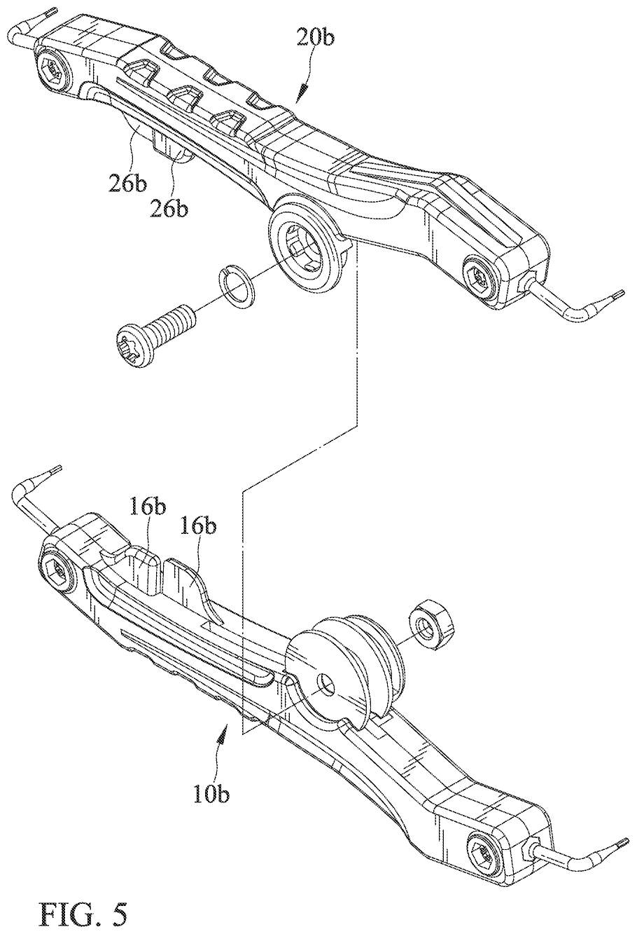

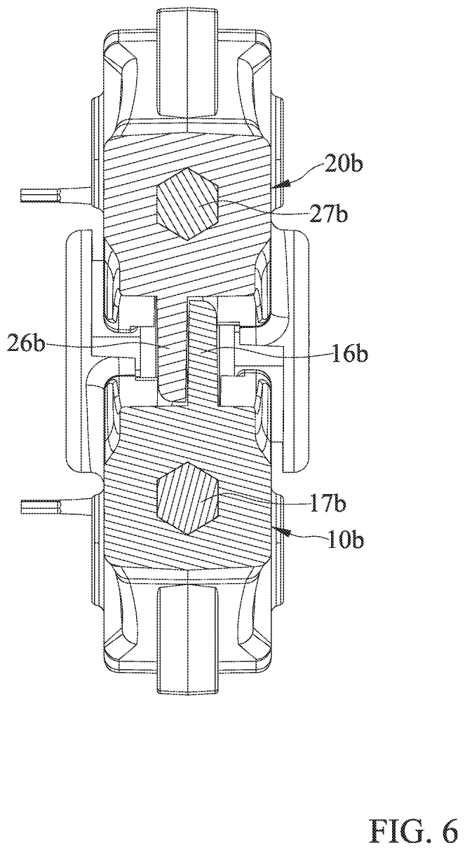

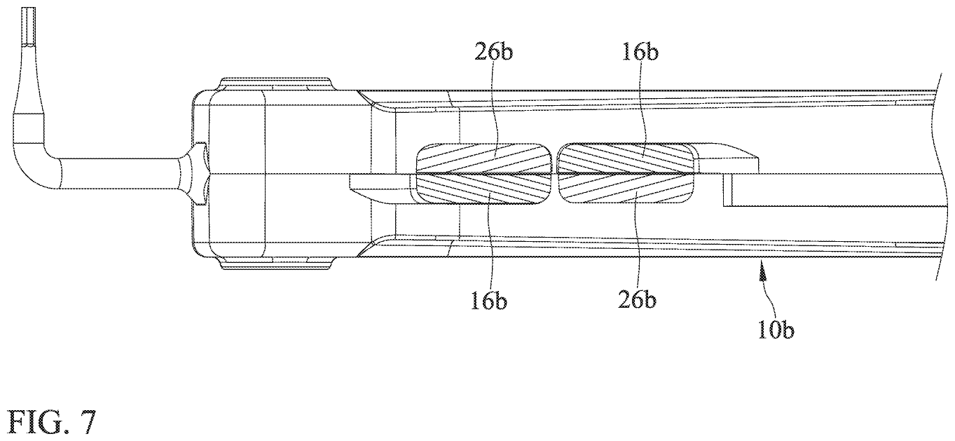

FIGS. 5-7 show a tool with two handles of a third embodiment according to the present invention. The third embodiment is substantially the same as the first embodiment but is mainly different from the first embodiment by that the first member 10b is embedded with a first metal reinforcing member 17b, and the second member 20b is embedded with a second metal reinforcing member 27b to increase the structure strength. Further, the two first limiting ribs 16b are staggered with each other along a width direction of the first member 10b. The two second limiting ribs 26b are staggered with each other along a width direction of the second member 20b. The two first limiting ribs 16b is configured to abut against the two second limiting ribs 26b when the first member 10b and the second member 20b pivot to each other.

Although specific embodiments have been illustrated and described, numerous modifications and variations are still possible without departing from the scope of the invention. The scope of the invention is limited by the accompanying claims.

1. A tool comprising:
a first member having at least one first working portion and a first pivoting portion;
a second member having at least one second working portion and a second pivoting portion;
a reinforcing device arranged between the first member and the second member and configured to abut in surface contact against the first pivoting portion and the second pivoting portion; and
a fastening assembly inserting through the first pivoting portion, the second pivoting portion, and the reinforcing device so that the first pivoting portion and the second pivoting portion are pivotally connected to each other.

2. The tool as claimed in claim 1, wherein the reinforcing device includes a first gasket, a second gasket and a spacer arranged between the first gasket and the second gasket, wherein the first gasket abuts in surface contact against the first pivoting portion, wherein the second gasket abuts in surface contact against the second pivoting portion, and wherein the spacer abuts against the first gasket and the second gasket.

3. The tool as claimed in claim 2, wherein the first pivoting portion has a first abutting face, wherein the first member further has a first abutting recess adjacent to the first abutting face, and a first containing recess spaced from the first abutting recess, wherein the second pivoting portion has a second abutting face, wherein the second member further has a second abutting recess adjacent to the second abutting face, and a second containing recess spaced from the second abutting recess;
wherein the first gasket is arranged in the first abutting recess and the second containing recess and has a first external side face abutting against the first abutting face, a first internal side face opposite to the first external side face, and a first through hole penetrating through the first external side face and the first internal side face;
wherein the second gasket is arranged in the second abutting recess and the first containing recess and has a second external side face abutting against the second abutting face, a second internal side face opposite to the second external side face, and a second through hole penetrating through the second external side face and the second internal side face;
wherein the spacer has a first end face, a second end face opposite to the first end face, and a third through hole penetrating through the first end face and the second end face;
wherein the fastening assembly includes a bolt and a nut threaded connected with the bolt, and wherein the bolt inserts through the first pivoting portion, the second pivoting portion, the first through hole, the second through hole, and the third through hole.

4. The tool as claimed in claim 2, wherein each of the first gasket and the second gasket is formed in a disc shape and has a circular cross sectional shape, and wherein the spacer is cylindrical and has a circular cross sectional shape.

5. The tool as claimed in claim 2, wherein the first gasket, the second gasket and the spacer are made of metal.

6. The tool as claimed in claim 1, wherein the number of the at least one first working portion of the first member is two, wherein the two first working portions are respectively disposed at two ends of the first member, and the first pivoting portion is disposed between the two first working portions, wherein the first member further has a first gripping portion arranged at an outer side thereof and disposed between one of the two first working portions and the first pivoting portion, wherein the number of the at least one second working portion of the second member is two, wherein the two second working portions are respectively disposed at two ends of the second member, and the second pivoting portion is disposed between the two second working portions, and wherein the second member further has a second gripping portion arranged at an outer side thereof and disposed between one of the two second working portions and the second pivoting portion.

7. The tool as claimed in claim 6, wherein the first member further has at least one first limiting rib disposed at an inner side thereof, wherein the second member further has at least one second limiting rib disposed at an inner side thereof, and wherein the at least one first limiting rib and the at least one second limiting rib abut against each other.

8. The tool as claimed in claim 7, wherein the number of the at least one first limiting rib of the first member is two, wherein the two first limiting ribs are spaced from each other, wherein the number of the at least one second limiting rib of the second member is two, wherein the two second limiting ribs are spaced from each other, and wherein one of the two first limiting ribs is configured to be located between the two second limiting ribs when the first member and the second member pivot to each other.

9. The tool as claimed in claim 7, wherein the number of the at least one first limiting rib of the first member is two, wherein the two first limiting ribs are staggered with each other along a width direction of the first member, wherein the number of the at least one second limiting rib of the second member is two, wherein the two second limiting ribs are staggered with each other along a width direction of the second member, and wherein the two first limiting ribs is configured to abut against the two second limiting ribs when the first member and the second member pivot to each other.

10. The tool as claimed in claim 9, wherein the first member is embedded with a first metal reinforcing member, and wherein the second member is embedded with a second metal reinforcing member.

11. The tool as claimed in claim 6, wherein the first member and the second member are made of metal.

12. The tool as claimed in claim 10, further comprising:
a elastic member arranged between the first member and the second member and configured to elastically bias the first member and the second member outward respectively, and wherein the elastic member is a torsion spring.

13. A tool comprising:
a first member having at least one first working portion and a first pivoting portion, and wherein the first member further has at least one first limiting rib disposed at an inner side thereof;
a second member having at least one second working portion and a second pivoting portion, wherein the second member further has at least one second limiting rib disposed at an inner side thereof, and wherein the at least one first limiting rib and the at least one second limiting rib abut against each other; and
a fastening assembly inserting through the first pivoting portion and the second pivoting portion so that the first pivoting portion and the second pivoting portion are pivotally connected to each other.

14. The tool as claimed in claim 13, wherein the number of the at least one first limiting rib of the first member is two, wherein the two first limiting ribs are spaced from each other, wherein the number of the at least one second limiting rib of the second member is two, wherein the two second limiting ribs are spaced from each other, and wherein one of the two first limiting ribs is configured to be located between the two second limiting ribs when the first member and the second member pivot to each other.

15. The tool as claimed in claim 13, wherein the number of the at least one first limiting rib of the first member is two, wherein the two first limiting ribs are staggered with each other along a width direction of the first member, wherein the number of the at least one second limiting rib of the second member is two, wherein the two second limiting ribs are staggered with each other along a width direction of the second member, and wherein the two first limiting ribs is configured to abut against the two second limiting ribs when the first member and the second member pivot to each other.
